(19) United States
(12) Patent Application Publication
(10) Pub. No.: US 2005/0188925 A1
(43) Pub. Date: Sep. 1, 2005

(54) Canine footwear

(76) Inventors: Yeu Hoon Yun, Beverly Hills, CA (US); John Carlos Ynostroza, Piedmont, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/095,927

(22) Filed: Mar. 31, 2005

Related U.S. Application Data
(60) Provisional application No. 60/589,506, filed on Jul. 19, 2004.

(51) Int. Cl. A43C 11/00; B68C 5/00

(52) U.S. Cl. 119/850; 54/82

(57) ABSTRACT

A dog shoe that is configured to be worn by a dog comprises a rubberized sole sized for a foot of a dog. The rubberized sole has an exterior portion and an upper portion opposite the exterior portion. The rubberized sole further includes a heel portion and a toe portion. The heel portion is raised in relation to the toe portion. The dog shoe further comprises a shoe wall that comprises a flexible material and that is coupled to at least a perimeter portion of the upper portion of the rubberized sole. The shoe wall includes an elongate opening along an upper portion thereof. The dog shoe further comprises a zipper that is mounted on opposite sides of the elongate opening in the upper portion of the shoe wall, the zipper is also configured to open and close an adjustable ankle opening in the upper portion of the shoe wall. The dog shoe further comprises an elastic ankle cinch that is mounted to the upper portion of the shoe wall. The elastic cinch is configured to cinch open and close the adjustable ankle opening.

### PRIORITY APPLICATION

This application claims the benefit of U.S. Provisional Patent Application 60/589,506, filed 19 Jul. 2004, the entire disclosure of which is hereby incorporated by reference herein.

### FIELD OF THE INVENTION

The present invention relates generally to canine footwear, and more specifically to canine footwear with improved features such as comfort, durability and appearance.

### BACKGROUND OF THE INVENTION

Canine footwear has been developed to mitigate the discomfort that dogs experience when standing, walking or running on harsh terrain, such as hot pavement, snow or rough surfaces. For example, seeing eye dogs and other service dogs are often subjected to hot, sun-baked pavement surfaces for prolonged periods of time. This can cause burning, cracking and/or infection of the dog's foot pads. Canine footwear also provides dogs with protection from hazards such as thorns, burrs, stinging insects, and salt used in street maintenance during wintry weather. These hazards can be particularly bothersome for dogs that spend a large amount of time indoors, because such dogs are unable to develop the tougher paw pads that dogs that spend a large amount of time outdoors have. Moreover, the advantages derived from canine footwear are not limited to providing comfort and protection from adverse environmental conditions. Canine footwear can also provide enhanced healing and protection for dogs with paw injuries; improved stability for dogs with arthritic, dysplastic or other conditions that adversely affect their ability to walk; and improved mobility for dogs that walk on slippery surfaces, such as hardwood floors or ice. Furthermore, it should be noted that the advantages derived from canine footwear are not limited to the dog wearing the footwear. Specifically, canine footwear can provide utility in the sense of decorations to help fulfill some sort of anthropomorphic kinship satisfaction to the dog owner.

### SUMMARY OF THE INVENTION

In view of the numerous advantages that canine footwear provides, several different types of canine footwear have been developed. However, many conventional forms of canine footwear suffer from significant disadvantages, such as a tendency to twist or slide off the dog's paw during certain activities, a failure to provide adequate ventilation to the dog's foot, and an inability to easily insert or remove the dog's foot from the shoe. These and other deficiencies are addressed by the improved canine footwear disclosed herein.

In one embodiment of the present invention, a dog shoe that is configured to be worn by a dog comprises a rubberized sole sized for a foot of a dog. The rubberized sole has an exterior portion and an upper portion opposite the exterior portion. The rubberized sole further includes a heel portion and a toe portion. The heel portion is raised in relation to the toe portion. The dog shoe further comprises a shoe wall that comprises a flexible material and that is coupled to at least a perimeter portion of the upper portion of the rubberized sole. The shoe wall includes an elongate opening along an upper portion thereof. The dog shoe further comprises a zipper that is mounted on opposite sides of the elongate opening in the upper portion of the shoe wall, the zipper is also configured to open and close an adjustable ankle opening in the upper portion of the shoe wall. The dog shoe further comprises an elastic ankle cinch that is mounted to the upper portion of the shoe wall. The elastic cinch is configured to cinch open and close the adjustable ankle opening.

In another embodiment of the present invention, a canine footwear apparatus comprises a rubber sole sized to fit a dog. The rubber sole has a dog toe portion and a dog heel portion opposite the dog toe portion. The dog heel portion is elevated with respect to the toe portion to accommodate a dog's anatomy. The canine footwear apparatus further comprises an upper shoe wall fastened to a perimeter portion of the sole and forming an upper ankle opening. The upper shoe wall is shaped to allow the footwear apparatus to be positioned on a dog foot. The upper shoe wall includes a first wall portion and a second wall portion. The first and second wall portions are at least partially separated. The canine footwear apparatus further comprises a fastener configured to secure the upper shoe first wall portion to the upper shoe second wall portion.

In another embodiment of the present invention, an enclosure for a dog paw comprises a shoe sole sized to fit a dog paw. The shoe sole has a toe portion and a heel portion opposite the toe portion. The dog paw enclosure further comprises a curved sidewall connected to and extending upwardly from a perimeter portion of the shoe sole to an adjustable ankle opening. The curved sidewall comprises a flexible material. The dog paw enclosure further comprises a longitudinally extending closable slit formed in the curved sidewall, and extending from a point adjacent the shoe sole toe portion to the adjustable ankle opening. The dog paw enclosure further comprises a closure device configured to open and close the longitudinally extending closable slit. The dog paw enclosure further comprises an elastic ankle cinch that is mounted to an upper portion of the curved sidewall, and that is configured to cinch open and close the adjustable ankle opening.

In another embodiment of the present invention, a kit comprises two first canine footwear articles having a first size. The kit further comprises two second canine footwear articles having a second size that is larger than the first size. The two first canine footwear articles and the two second canine footwear articles each include a rubberized sole having a raised heel portion. The two first canine footwear articles and the two second canine footwear articles each include a shoe wall that is made of a flexible material and that is attached to a perimeter portion of the rubberized sole. The two first canine footwear articles and the two second canine footwear articles each include an elastic ankle cinch that is mounted to an upper portion of the shoe wall, and that is configured to cinch open and close an adjustable ankle opening in the shoe wall.

### BRIEF DESCRIPTION OF THE DRAWINGS

Exemplary embodiments of the improved canine footwear disclosed herein are illustrated in the accompanying drawings, which are for illustrative purposes only. The drawings comprise the following figures, in which like numerals indicate like parts.

FIG. 1 is a perspective view of a dog wearing an exemplary embodiment of the improved canine footwear disclosed herein.

FIG. 2 is a first side view of an exemplary embodiment of a canine footwear apparatus having an elastic ankle cinching mechanism.

FIG. 3 is a second side view of the canine footwear apparatus of FIG. 2.

FIG. 4 is a front view of the canine footwear apparatus of FIG. 2.

FIG. 5 is a rear view of the canine footwear apparatus of FIG. 2.

FIG. 6 is a bottom view of the canine footwear apparatus of FIG. 2 illustrating an exemplary sole configuration.

FIG. 7 is a first side view of an exemplary embodiment of a canine footwear apparatus having a raised heel.

FIG. 8 is a front view of the canine footwear apparatus of FIG. 7.

FIG. 9 is a rear view of the canine footwear apparatus of FIG. 7.

FIG. 10 is a bottom view of the canine footwear apparatus of FIG. 7 illustrating an exemplary sole configuration.

### DETAILED DESCRIPTION OF PREFERRED EMBODIMENTS

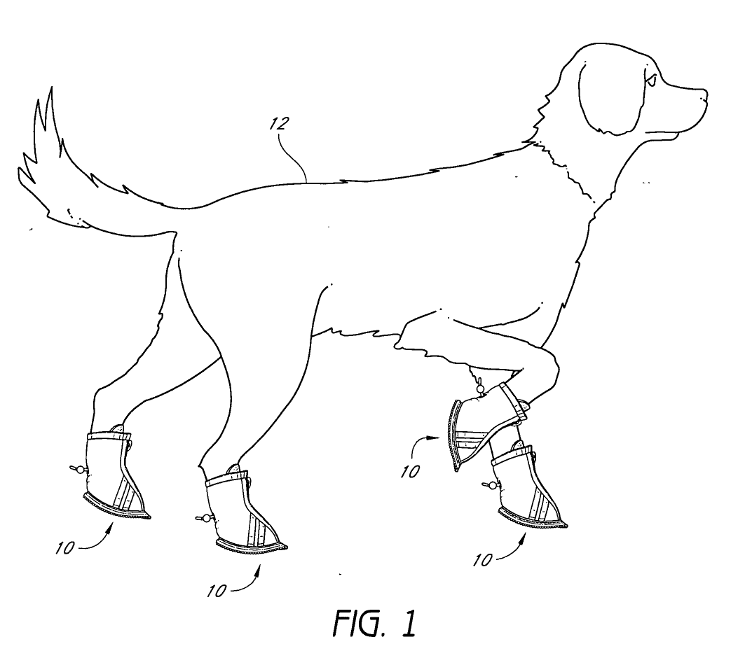

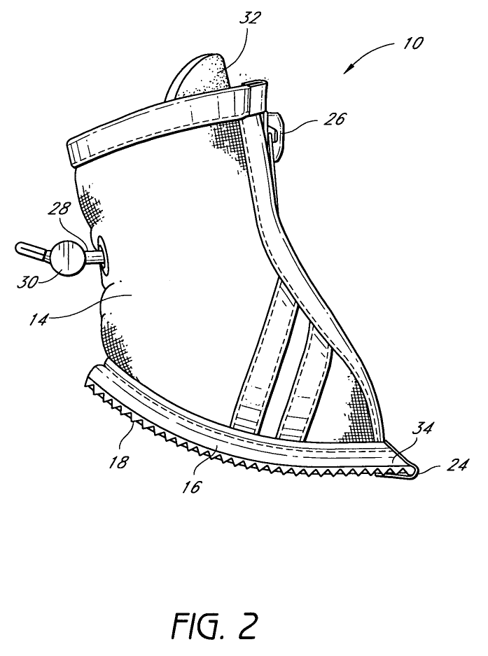

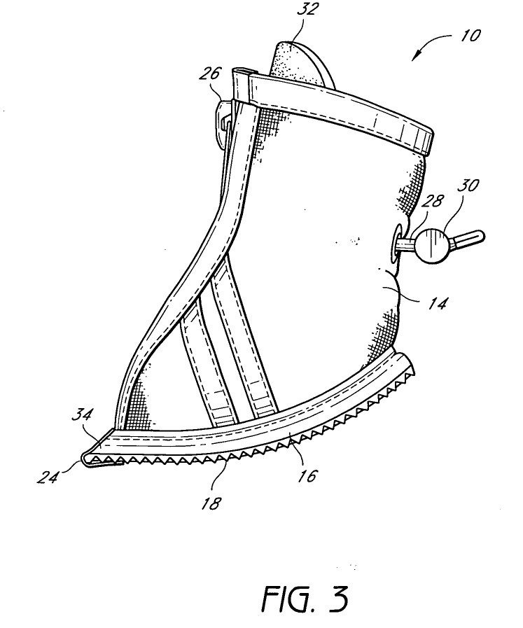

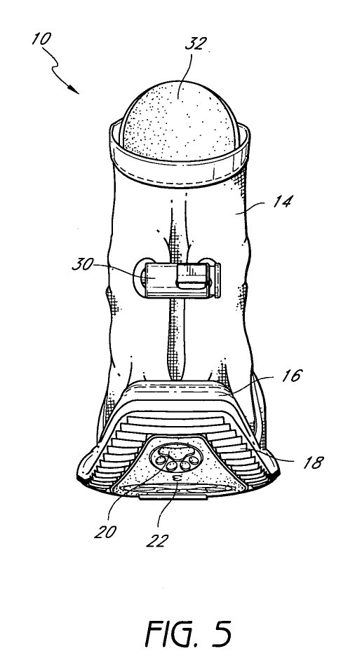

In accordance with the forgoing, improved canine footwear has been developed. FIG. 1 illustrates an exemplary embodiment of canine footwear 10 worn by a dog 12. Certain features of the canine footwear 10 are illustrated in greater detail in FIGS. 2 through 6.

In an exemplary embodiment, the canine footwear 10 comprises a sole 16 that is made of rubber, although other suitable materials such as leather or canvas can be used in other embodiments. A slip-resistant sole, such as a rubber sole, provides several advantages, such as increased durability and wear resistance, enhanced protection from dangers such as thorns or burrs, and improved traction on various types of slippery terrain. For example, a rubber sole will provide a dog with enhanced traction on a polished wood floor, thus facilitating the dog's movement and decreasing the risk of injury due to a fall. Furthermore, many dogs suffering from certain conditions such as arthritis find that the increased traction provided by a slip-resistant sole makes it easier to stand up from a sitting or lying condition,

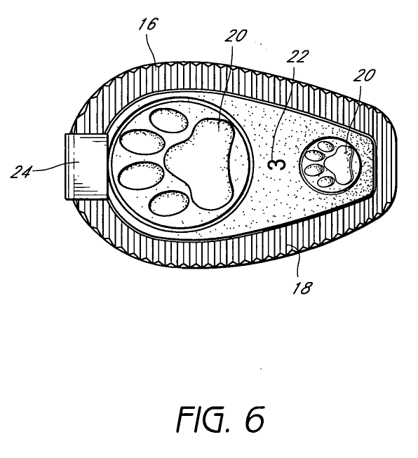

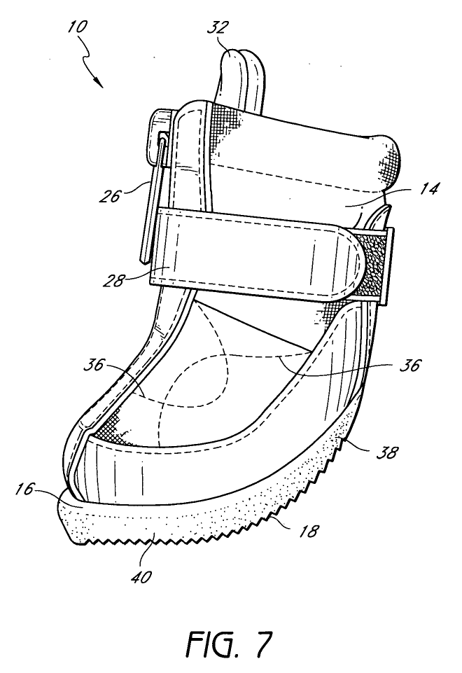

The sole 16 optionally includes tread 18 to further enhance traction. As illustrated in FIG. 6, in an exemplary embodiment the tread 18 includes one or more dog paw patterns 20. Additionally, in certain embodiments the sole 16 further includes a size indicator 22 printed thereon. The size indicator 22, which in an exemplary embodiment comprises one or more alphanumeric characters, provides an indication of the size of a particular article of canine footwear.

The canine footwear 10 further includes a shoe wall 14 that is configured to cover an upper portion of the dog's foot. In an exemplary embodiment, the shoe wall 14 comprises a flexible, porous material, such as canvas, nylon or polytetrafluoroethylene, thereby allowing air to pass through the shoe wall 14 to the dog's foot, and allowing moisture to pass from the dog's foot through the shoe wall 14. Such a configuration is particularly advantageous for canine footwear because a dog perspires through its feet. In an exemplary embodiment, the inner surface of the shoe wall 14 comprises a soft fleece-like material or similar material to enhance comfort for the dog's foot.

Optionally, the shoe wall 14 further includes macroscopic pores to further facilitate passage of air and moisture therethrough. In a modified embodiment, the shoe wall is at least partially coated with a material configured to resist water damage, such as a water-resistant material. An example of such a material is carnauba wax. Such surface treatments are particularly advantageous where the canine footwear is to be used to prevent a dog's foot from becoming wet.

Still referring to in exemplary embodiment illustrated in FIGS. 2 through 6, the shoe wall 14 is secured to a perimeter portion of the sole 16. In one embodiment the shoe wall 14 is sewn to the sole 16, although other attachment mechanisms, such as use of an epoxy, are used in other embodiments. For example, FIGS. 2 through 6 illustrate the use of a clip 24, such as a metallic clip, to secure the shoe wall 14 to a toe portion 34 of the sole 16. In other embodiments, additional clips 24 can be used at other locations around the perimeter of the sole 16.

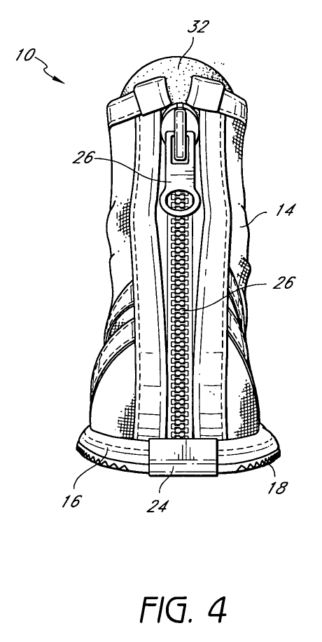

The shoe wall 14 includes an elongate opening to facilitate placement of the dog's foot within the canine footwear 10. In the exemplary embodiment illustrated in FIG. 4, the elongate opening includes a zipper 26. However, other mechanisms to open and close the elongate opening are used in other embodiments; examples of such mechanisms include snaps, buttons, clips and hook-and-loop type fasteners. The canine footwear 10 optionally includes a tongue 32 positioned inside the shoe and over the elongate opening, thereby providing a buffer between the dog's foot and the elongate opening. Aside from providing an added level of comfort, the tongue 32 also optionally protects the dog's foot from the mechanism used to open and close the elongate opening. For example, in embodiments wherein a zipper is used to open and close the elongate opening, the tongue 32 helps to prevent fur on the dog's foot from becoming entangled in the zipper.

In an exemplary embodiment, an upper portion of the shoe wall 14 additionally or optionally includes an ankle cinch 28. For example, in one embodiment the ankle cinch 28 comprises an elastic cord that is configured to be tightened around an upper portion of the dog's ankle. In such embodiments, the ankle cinch includes a pushbutton lock 30 usable to keep the elastic cord in a tightened configuration. Other mechanisms for keeping the elastic cord in a tightened configuration are used in other embodiments. The ankle cinch advantageously helps to keep the canine footwear 10 secured to the dog's foot, and helps to reduce the tendency of the canine footwear 10 to slip, twist, slide or otherwise fall off of the dog's foot during certain activities, such as strenuous physical activities. This ankle cinch configuration also advantageously provides substantially unhindered movement of the dog's leg and foot tendons.

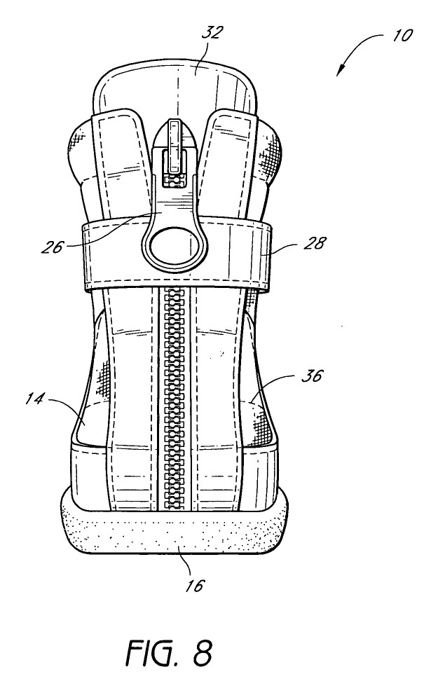

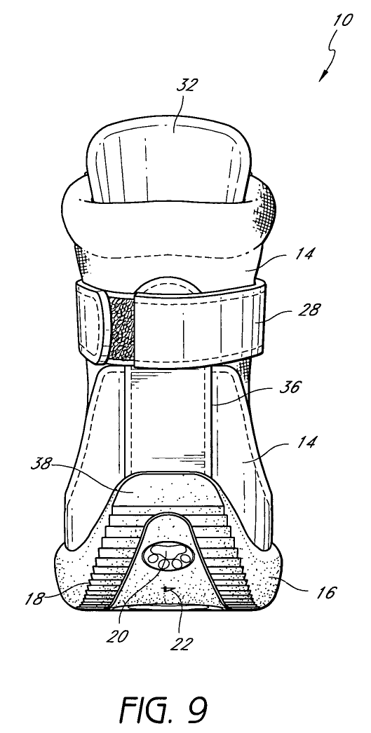

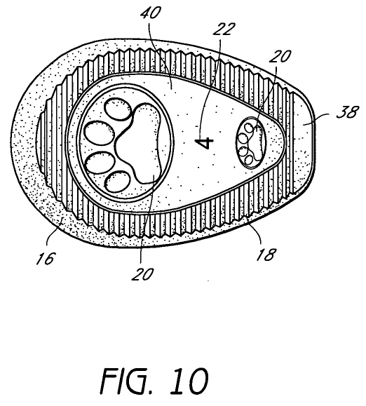

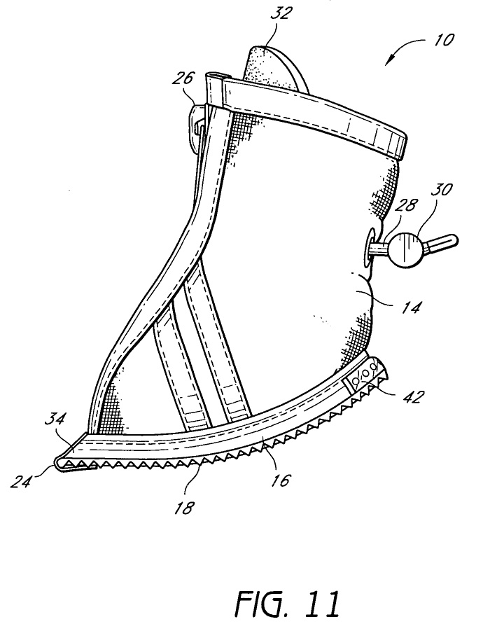

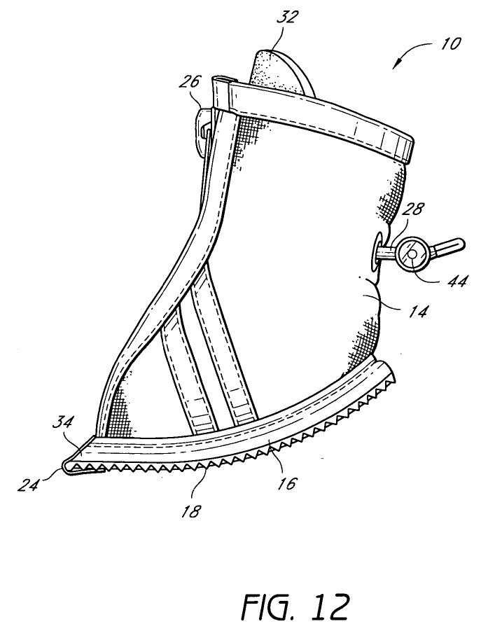

Modified embodiments of canine footwear 10 are illustrated in FIGS. 7 through 10. Such embodiments include a hook-and-loop type fastener for the ankle cinch 28 instead of an elastic cord. FIG. 8 illustrates that the ankle cinch 28 is optionally positioned over the elongate opening, as distinguished from the exemplary configuration using an elastic cord that is illustrated in FIG. 4. Furthermore, the modified embodiments illustrated in FIGS. 7 through 10 illustrate that the shoe wall 14 optionally comprises a plurality of smaller shoe wall panels that are interconnected using, for example, stitching 36. However, other mechanisms are used to interconnect the smaller shoe wall panels in other embodiments.

The modified embodiments illustrated in FIGS. 7 through 10 included a raised heel portion 38 of the sole 16. For example, in one embodiment the raised heel portion 38 is inclined at an angle between about 5° and about 50° with respect to a foot portion 40 of the sole. In another embodiment, the raised heel portion 38 is inclined at an angle between about 5° and about 30° with respect to the foot portion 40 of the sole. Other heel inclination angles are used in other embodiments. Inclining the heel portion 38 of the sole advantageously conforms to the unique anatomy of the canine foot, thereby providing significant comfort advantages with respect to flat-soled canine footwear.

As described herein, in certain embodiments, canine footwear 10 with various sized soles is produced. The size of the sole is optionally provided by an alphanumeric size indicator 22 marked on the sole 16. However, in certain embodiments components of the canine footwear other than or in addition to the sole 16 are provided in various sizes. For example, the height of the shoe wall 14 is adjustable. In one embodiment, the height of the shoe wall 14 is between about one inch and about 5 inches. In another embodiment, the height of the shoe wall 14 is between about 2 inches and about 4 inches. In still another embodiment, the shoe wall 14 is provided with a height configured to reach to a region adjacent to an ankle of the dog.

Generally, a dog's front paws are slightly larger than a dog's rear paws. Therefore, in certain embodiments wherein four dog boots are provided in a kit, the kit comprises two smaller dog boots intended for the dog's rear paws, and two slightly larger dog boots intended for the dog's front paws. In embodiments wherein the dog boot includes a size indicator, the kit optionally includes packaging that allows the size indicators to be seen through the packaging, thereby making it easier for a consumer to procure appropriately-sized canine footwear.

### SCOPE OF THE INVENTION

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than canine footwear.

1. A dog shoe configured to be worn by a dog, the shoe comprising:
a rubberized sole sized for a foot of a dog, the rubberized sole having an exterior portion and an upper portion opposite the exterior portion, and further including a heel portion and a toe portion, wherein the heel portion is raised in relation to the toe portion;
a shoe wall that comprises a flexible material and that is coupled to at least a perimeter portion of the upper portion of the rubberized sole, wherein the shoe wall includes an elongate opening along an upper portion thereof;
a zipper that is mounted on opposite sides of the elongate opening in the upper portion of the shoe wall, and that is configured to open and close an adjustable ankle opening in the upper portion of the shoe wall; and
an elastic ankle cinch that is mounted to the upper portion of the shoe wall, and that is configured to cinch open and close the adjustable ankle opening.

2. The dog shoe of claim 1, wherein the rubberized sole has a heel inclination angle between about 5° and about 50°.

3. The dog shoe of claim 1, wherein the exterior portion of the rubberized sole includes a numbered size indicator that provides an indication of paw size the dog shoe will fit.

4. The dog shoe of claim 1, wherein the shoe wall is attached to the rubberized sole using an adhesive.

5. The dog shoe of claim 1, wherein the shoe wall is sewn onto the rubberized sole.

6. The dog shoe of claim 1, wherein the shoe wall comprises nylon.

7. The dog shoe of claim 1, wherein the shoe wall includes a plurality of ventilation holes.

8. The dog shoe of claim 1, wherein at least a portion of the dog shoe wall is coated with a water resistant material or coating.

9. The dog shoe of claim 1, wherein at least a portion of the dog shoe wall is coated at least in part with carnauba wax.

10. The dog shoe of claim 1, wherein the shoe wall has a height between about 1 inch and about 5 inches.

11. The dog shoe of claim 1, wherein the shoe wall has a height sized to reach to a region adjacent to an ankle of the dog.

12. A canine footwear apparatus comprising:
a rubber sole sized to fit a dog, the rubber sole having a dog toe portion and a dog heel portion opposite the dog toe portion, wherein the dog heel portion is elevated with respect to the toe portion to accommodate a dog's anatomy;
an upper shoe wall fastened to a perimeter portion of the sole and forming an upper ankle opening, wherein the upper shoe wall is shaped to allow the footwear apparatus to be positioned on a dog foot, and wherein the upper shoe wall includes a first wall portion and a second wall portion, wherein the first and second wall portions are at least partially separated; and
a fastener configured to secure the upper shoe first wall portion to the upper shoe second wall portion.

13. The canine footwear apparatus of claim 12, wherein the first and second wall portions are separated by an opening.

14. The canine footwear apparatus of claim 12, wherein the rubber sole has a heel inclination angle between about 5° and about 50°.

15. The canine footwear apparatus of claim 12, wherein the rubber sole has a heel inclination angle between about 5° and about 30°.

16. The canine footwear apparatus of claim 12, wherein the fastener is a zipper.

17. The canine footwear apparatus of claim 12, wherein the fastener is a hook-and-loop type fastener.

18. The canine footwear apparatus of claim 12, further comprising an elastic ankle cinch coupled to the upper ankle opening, wherein the elastic ankle cinch is configured to adjust a size of the upper ankle opening.

19. An enclosure for a dog paw, the enclosure comprising:
a shoe sole sized to fit a dog paw, the shoe sole having a toe portion and a heel portion opposite the toe portion;
a curved sidewall connected to and extending upwardly from a perimeter portion of the shoe sole to an adjustable ankle opening, wherein the curved sidewall comprises a flexible material;
a longitudinally extending closable slit formed in the curved sidewall, and extending from a point adjacent the shoe sole toe portion to the adjustable ankle opening;
a closure device configured to open and close the longitudinally extending closable slit; and
an elastic ankle cinch that is mounted to an upper portion of the curved sidewall, and that is configured to cinch open and close the adjustable ankle opening.

20. The dog paw enclosure of claim 19, wherein the closure device is one of a hook-and-loop fastener and a zipper.

21. The dog paw enclosure of claim 19, further comprising an alphanumeric size indicator positioned on an exterior portion of the shoe sole.

22. The dog paw enclosure of Claim. 19, wherein the heel portion of the shoe sole is inclined with respect to the toe portion of the shoe sole.

23. The dog paw enclosure of claim 19, further comprising a plurality of ventilation holes formed in the curved sidewall.

24. The dog paw enclosure of claim 19, further comprising a water-resistance surface treatment applied to the curved sidewall.

25. A kit comprising:
two first canine footwear articles having a first size; and
two second canine footwear articles having a second size that is larger than the first size,
wherein the two first canine footwear articles and the two second canine footwear articles each include:
a rubberized sole having a raised heel portion,
a shoe wall that is made of a flexible material and that is attached to a perimeter portion of the rubberized sole, and
an elastic ankle cinch that is mounted to an upper portion of the shoe wall, and that is configured to cinch open and close an adjustable ankle opening in the shoe wall.

26. The kit of claim 25, wherein the two first canine footwear articles and the two second canine footwear articles each includes an alphanumeric size inductor.

27. The kit of claim 25,
wherein the two first canine footwear articles and the two second canine footwear articles each includes an alphanumeric size inductor; and
further comprising packaging configured to hold the two first canine footwear articles and the two second canine footwear articles such that the alphanumeric size indicator is visible through the packaging.
